(19) United States
(12) Patent Application Publication
(10) Pub. No.: US 2010/0050796 A1
(43) Pub. Date: Mar. 4, 2010

(54) HIGH LOAD LIFT AND SHOCK LINEAR ACTUATOR

(75) Inventors: David M. Eschborn, Gilbert, AZ (US); Glenn Harold Lane, Chandler, AZ (US)

Correspondence Address: HONEYWELL/IFL;Patent Services, 101 Columbia Road, P.O.Box 2245, Morristown, NJ, 07962-2245, US

(73) Assignee: Honeywell International Inc., Morristown, NJ (US)

(21) Appl. No.: 12/204,661

(22) Filed: Sep. 4, 2008

(51) Int. Cl. F16H 25/20

(52) U.S. Cl. 74/89.37

(57) ABSTRACT

A high load and shock linear actuator is provided that may be used to position a hatch on a waterborne platform. The actuator includes a power-screw actuator, a manual operator, a bidirectional brake, an actuator motor, and a motor brake. The power-screw actuator is coupled to receive a drive torque from either the actuator motor or the manual operator, and is responsive to this drive torque to position the hatch. The bidirectional brake transfers manual input torque supplied to its input by the manual operator, and prevents torque supplied to its output from being transferred to its input. The actuator motor includes a stator, a rotor, a ring gear, and a differential carrier assembly. The differential carrier assembly is disposed within the rotor inner volume. The motor brake is mounted adjacent the actuator motor and selectively prevents and allows actuator motor rotation.

### TECHNICAL FIELD

The present invention generally relates to linear actuators and, more particularly to an electromechanical actuator (EMA) that exhibits relatively high load and relatively high shock capability.

### BACKGROUND

Actuators are used in myriad devices and systems. For example, many vehicles including, for example, aircraft, spacecraft, watercraft, and numerous other terrestrial and non-terrestrial vehicles, include one or more actuators to effect the movement of various control surfaces or components. In many applications electromechanical actuators (EMAs) are used. An EMA typically includes an electric motor that, when properly energized, supplies a torque to a suitable actuation device, which in turn positions a component.

In some applications, there is a need for actuators that exhibits relatively high load and relatively high shock capability, while at the same time fitting within a relatively small space envelope. For example, certain waterborne military platforms, such as submarines, need actuators that can fit within its relatively confined space and that also exhibit high load and shock capability. One specific submarine system that relies on actuators with these characteristics is a hatch actuation control system. In the past, these systems have included hydraulic-type actuators, which can be relatively heavy, complex, and maintenance intensive.

Hence, there is a need for an EMA that exhibits relatively high load and relatively high shock capability, while at the same time fits within a relatively small space envelope, such as a submarine. The present invention addresses at leas this need.

### BRIEF SUMMARY

In one embodiment, and by way of example only, a high load lift and shock linear actuator includes a power-screw actuator, a manual operator, a bidirectional brake, an actuator motor, and a motor brake. The power-screw actuator is coupled to receive a drive torque and is operable, upon receipt thereof, to translate. The manual operator is configured to be manually rotated and is operable, upon being manually rotated, to supply a manual input torque. The bidirectional brake has an input and an output. The bidirectional brake input is coupled to the manual operator. The bidirectional brake is configured to transfer manual input torque from the bidirectional brake input to the bidirectional brake output, and prevent torque supplied to the bidirectional brake output from being transferred to the bidirectional brake input. The actuator motor is coupled to the power-screw actuator and is adapted to be selectively energized. The actuator motor is operable, upon being energized, to supply the drive torque to the power-screw actuator. The actuator motor includes a stator, a rotor, a ring gear, and a differential carrier assembly. The rotor is disposed within, and is spaced apart from, the stator, and has an inner surface that defines an inner volume. The ring gear is mounted on the rotor inner surface. The differential carrier assembly is disposed within the rotor inner volume and includes a carrier, a sun gear, and a plurality of planet gears. The carrier is rotationally mounted within the rotor and is coupled to the power-screw actuator. The sun gear is rotationally mounted within the carrier and is coupled to the bidirectional brake output. Each planet gear is disposed between and engages the sun gear and the ring gear. The motor brake is mounted adjacent the actuator motor and is selectively movable between an engaged position, in which the motor brake at least inhibits rotation of the actuator motor rotor, and a disengaged position, in which the motor brake does not at least inhibit rotation of the actuator motor rotor.

In another exemplary embodiment, a high load lift and shock actuation control system includes the above-described actuator and an actuator controller that is operable to controllably energize the actuator motor and to controllably energize and deenergize the motor brake.

In yet another exemplary embodiment, a submarine hatch position control system uses the above-described system to controllably move a submarine hatch.

Other desirable features and characteristics of the actuator and actuation control system will become apparent from the subsequent detailed description of the invention and the appended claims, taken in conjunction with the accompanying drawings and this background of the invention.

### BRIEF DESCRIPTION OF THE DRAWINGS

The present invention will hereinafter be described in conjunction with the following drawing figures, wherein like numerals denote like elements, and wherein:

FIG. 1 depicts an exemplary embodiment of a hatch actuation control system coupled to a hatch on a waterborne platform;

FIG. 2 is an alternative view of the exemplary system depicted in FIG. 1;

FIG. 3 is a close up cross section view of the exemplary hatch actuation control system of FIGS. 1 and 2, taken along line 3-3 in FIG. 1;

FIG. 4 is a cross section views of the exemplary system depicted in FIGS. 1 and 2, and taken along line 4-4 in FIG. 2, with the hatch in its open position;

FIG. 5 is a cross section views of the exemplary system depicted in FIGS. 1 and 2, and taken along line 4-4 in FIG. 2, with the hatch in its closed position;

FIG. 6 depicts a close up cross section view of an exemplary actuation motor, manual operator, and intervening hardware that may be used to implement the system of FIG. 1; and

FIGS. 7 and 8 are perspective and end views, respectively, of an exemplary differential carrier assembly that may be used to implement the actuation motor of FIG. 6; and

FIG. 9 is a cross section view of the exemplary differential carrier assembly taken along line 9-9 in FIG. 8.

### DETAILED DESCRIPTION

The following detailed description is merely exemplary in nature and is not intended to limit the invention or the application and uses of the invention. Furthermore, there is no intention to be bound by any theory presented in the preceding background or the following detailed description. In this regard, although the actuator and actuation control system are described as being implemented in a submarine environment, and to control a submarine hatch, the actuator and associated control system may be implemented in numerous other environments and/or to control numerous other devices or components.

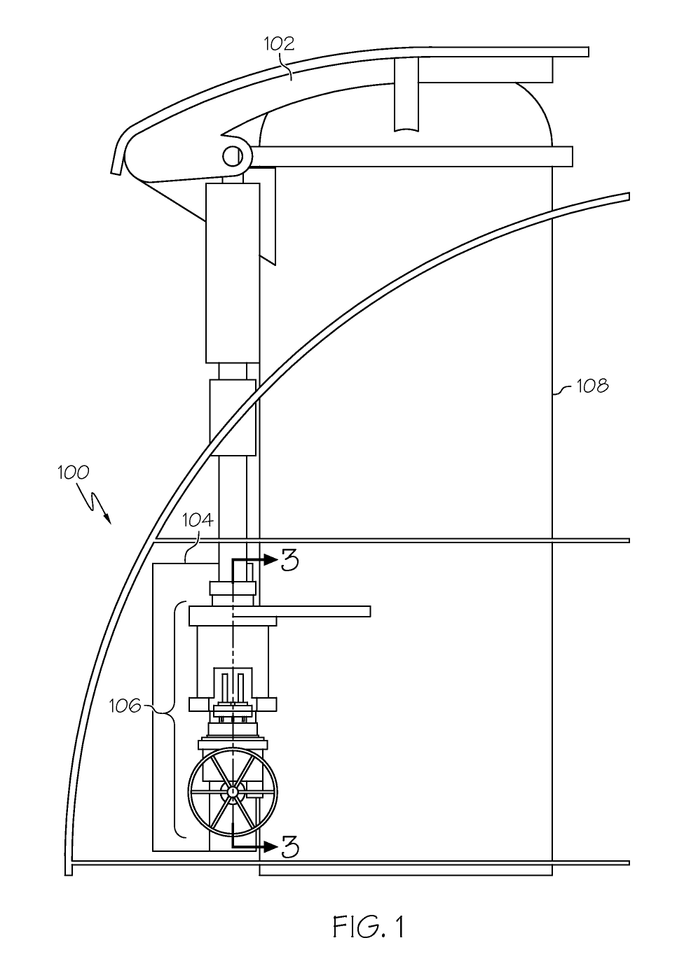

Referring now to FIG. 1, a hatch actuation control system 100 is depicted. The control system may be used, for example, to position a submarine hatch 102 and includes an actuator controller 104 and an actuator 106. In the depicted embodiment the hatch 102 is a for a submarine missile silo 108. It will be appreciated, however, that the hatch 102 may be used to seal and unseal any one of numerous openings in a submarine or other waterborne vessel. For example, the hatch 102 could be a bulkhead hatch, a torpedo door, or a personnel access hatch, just to name a few. The hatch 102 is rotationally mounted on support structure, which may, for example, form part of a submarine outer hull or be coupled to a submarine outer hull. In any case, the hatch 102 is movable, as will be depicted and described later on, between it closed position, which is the position depicted in FIG. 1, and a full-open position.

The hatch 102 is moved between the closed and full-open positions via the hatch actuation control system 100. As noted above, the hatch actuation control system 100 includes the actuator controller 104 and the actuator 106. The actuator controller 104 is coupled to receive commands from a remote, non-illustrated external system, or via a non-illustrated user interface. The actuator controller 104 is responsive to these commands, whether received remotely or input locally, to control the actuator 106. More specifically, and as will be described in more detail further below, the actuator 106 includes a motor. Thus, the actuator controller 104 controllably energizes the motor from a non-illustrated power supply to control the position of the actuator 106, and hence the position of the hatch 102.

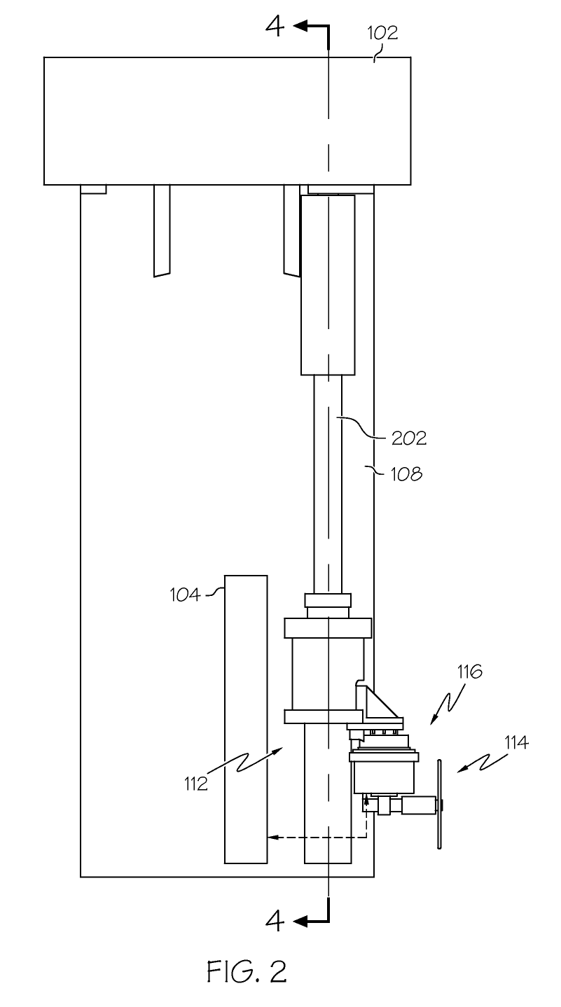

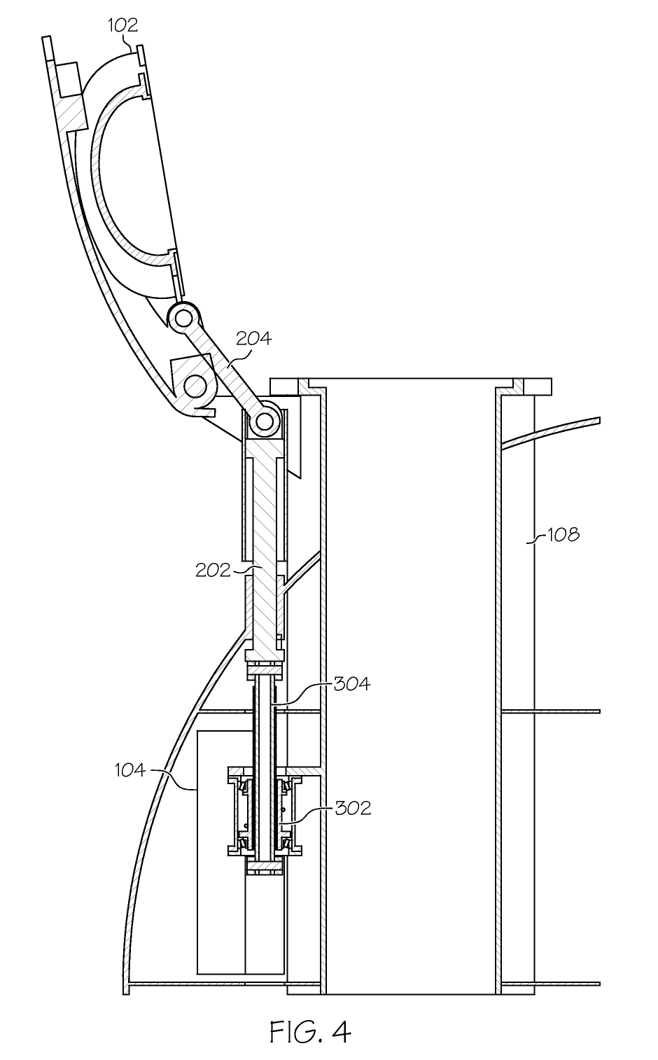

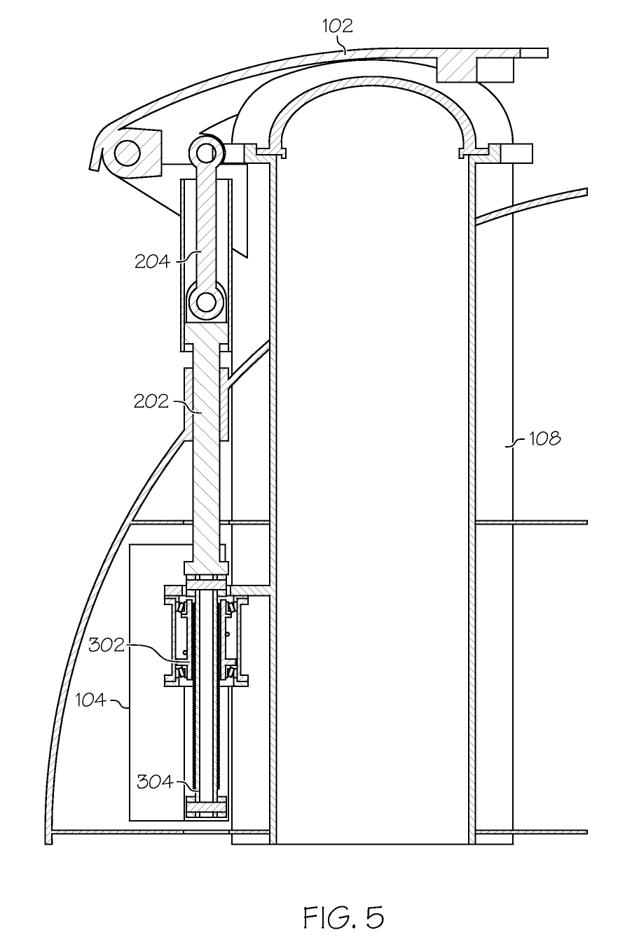

The actuator 106 is coupled to the hatch 102 and, at least in the depicted embodiment, is mounted to the silo 108. The actuator 106 is structurally configured as a relatively high load and relatively high shock device and, as may be seen more clearly in FIG. 2, includes a power-screw actuator 112, a manual operator 114, and an actuator motor 116. The power-screw actuator 112 is coupled to the hatch 102 via interconnecting hardware. In the depicted embodiment, this interconnecting hardware includes a plunger 202 and a hatch link 204 (visible in FIGS. 4 and 5). The plunger 202 is coupled between the power-screw actuator 112 and the hatch link 204, and the hatch link 204 is coupled to the hatch 102. The power-screw actuator 112 is also coupled to receive a drive torque and is operable, upon receipt of the drive torque, to translate and supply a drive force, via the plunger 202 and hatch link 204, to the hatch 102. This drive force is used to position the hatch 102.

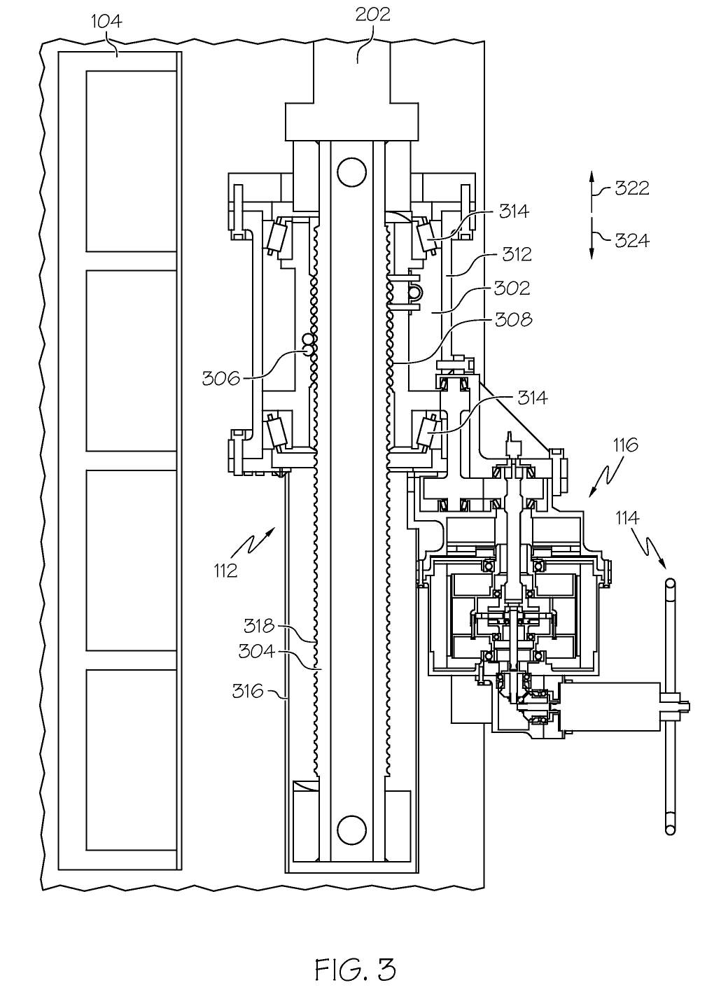

To provide this functionality the power-screw actuator 112 may be implemented as any one of numerous suitable power-screw actuators. For example, it may be implemented as a ball screw actuator, a roller screw actuator, or an acme screw actuator, just to name a few. In the depicted embodiment, as is depicted more clearly in FIG. 3, the power-screw actuator 112 is implemented as a ball screw actuator that includes a ballnut 302, a ballscrew 304, and a plurality of interposed balls 306. The ballnut 302 has grooves 308 formed on a portion of its inner surface, and is rotationally mounted within a ballnut housing 312 via, for example, tapered bearings 314, and is constrained against axial movement. The ballnut 302 is coupled to receive a drive torque, from either the manual operator 114 or the actuator motor 116, and rotates upon receipt of the drive torque.

The ballscrew 304 extends axially through the ballnut 302, and into a ballscew shield 316 that is coupled to the ballscrew housing 312. The ballscrew 304 has grooves 318 formed on a portion of its outer surface that are configured identical, or at least substantially identical, to the grooves 308 on the ballnut 302. The balls 306 are disposed between the ballnut 302 and the ballscrew 304 within a least a portion of the grooves 308, 318. The ballscrew 304 is constrained against rotation, but may move axially. Thus, whenever the ballnut 302 rotates, the ballscrew translates axially in either a first direction 322 or a second direction 324, depending upon the direction in which the ballnut 302 is rotated. Because the ballscrew 304 is coupled to the plunger 202, axial movement of the ballscrew 304 in the first direction 322 will result in the hatch 102 moving toward the full-open position, as shown in FIG. 4, whereas axial movement of the ballscrew 304 in the second direction 324 will result in the hatch 102 moving toward the closed position, as shown in FIG. 5.

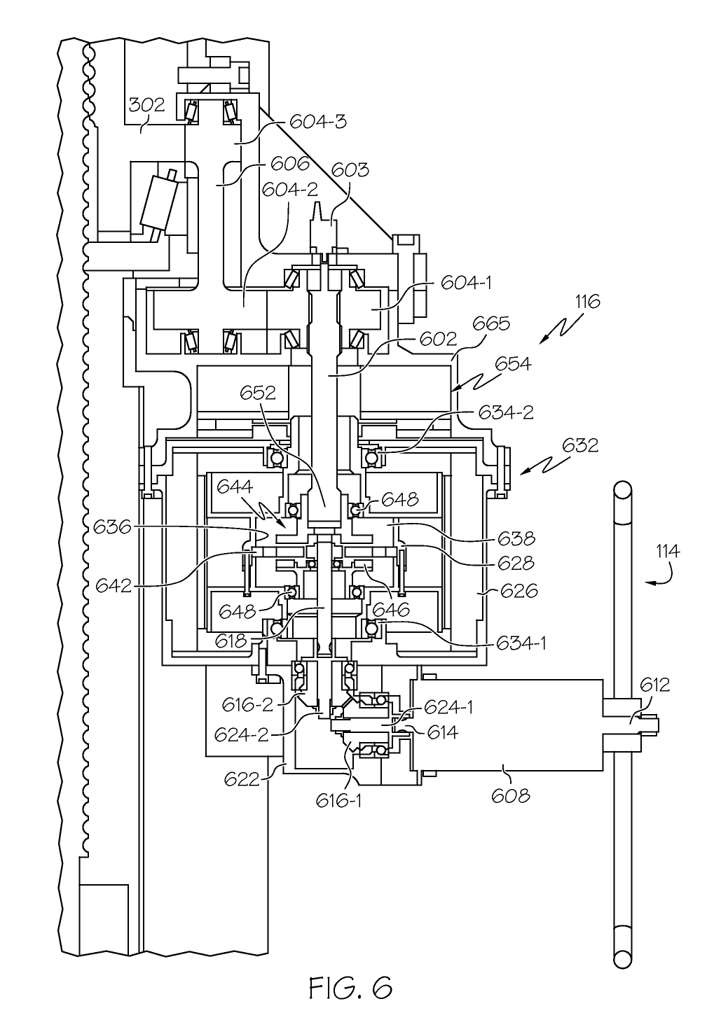

As was noted above, the power-screw actuator 112, and more specifically the ballnut 302, receives a drive torque from either the manual operator 114 or the actuator motor 116. Turning now to FIG. 6, it is seen that this drive torque, whether originating from the manual operator 114 or the actuator motor 116, is coupled to the power-screw actuator 112 via an output shaft 602 and a plurality of output gears 604 (e.g., 604-1, 604-2, 604-3). More specifically, the output shaft 602 is coupled to receive a drive torque from either the manual operator 114 or the actuator motor 116. The manner in which this occurs is described in more detail further below. Nonetheless, it is seen that the output shaft 602 is coupled to a rotationally mounted first output gear 604-1. The first output gear 604-1 engages a rotationally mounted second output gear 604-2, which is coupled to a rotationally mounted third output gear 604-3 via an interconnecting shaft 606. The third output gear 604-3 in turn engages the ballnut 302. The depicted actuator 106 additionally includes a position sensor 603. The position sensor 603 is a rotational position sensor that is coupled to, and is operable to sense the rotational position of, the output shaft 602, and to supply a position feedback signal representative thereof. The position sensor 603 is also in operable communication with, and supplies the position feedback signal to, the actuator controller 104.

The manual operator 114 and the actuator motor 116, as has been repeatedly described, may supply a drive torque to the power-screw actuator 112 via the just-described output shaft 602 and output gears 604. The configuration of the manual operator 114 and actuator motor 116 that implement this functionality will now be described, beginning with the manual operator 114. With continued reference to FIG. 6, it may be seen that the manual operator 114 is coupled to a bidirectional brake 608. The bidirectional brake 608 may be implemented using any one of numerous bidirectional brakes (or bidirectional no-back devices) now known or developed in the future, and includes an input 612 and an output 614. The bidirectional brake input 612 is coupled to the manual operator 114 and the bidirectional brake output 614 is coupled, via a plurality of input gears 616 (e.g., 616-1, 616-2), to a manual input shaft 618. In the depicted embodiment, the input gears 616 are disposed within a housing assembly 622, and each gear includes a splined shaft 624. The first input gear splined shaft 624-1 engages the bidirectional brake output 614, and the second input gear splined shaft 624-2 engages the manual input shaft 618. It will be appreciated that the number, configuration, and coupling method of the input gears 616 that is depicted and described herein is merely exemplary, and may vary with different system operational needs.

The bidirectional brake 608, as is conventional, is configured to transfer manual input torque, supplied to the bidirectional brake input 612 via the manual operator 114, from the bidirectional brake input 612 to the bidirectional brake output 614. The bidirectional brake 608 is also configured, as is conventionally known, to prevent torque supplied to the bidirectional brake output 614, via the manual input shaft 618 and input gears 616, from being transferred to the bidirectional brake input 612. With this configuration, the bidirectional brake 608 prevents the manual input shaft 618 from rotating in response to any torque acting on the manual input shaft 618 that does not originate from the bidirectional brake input 612.

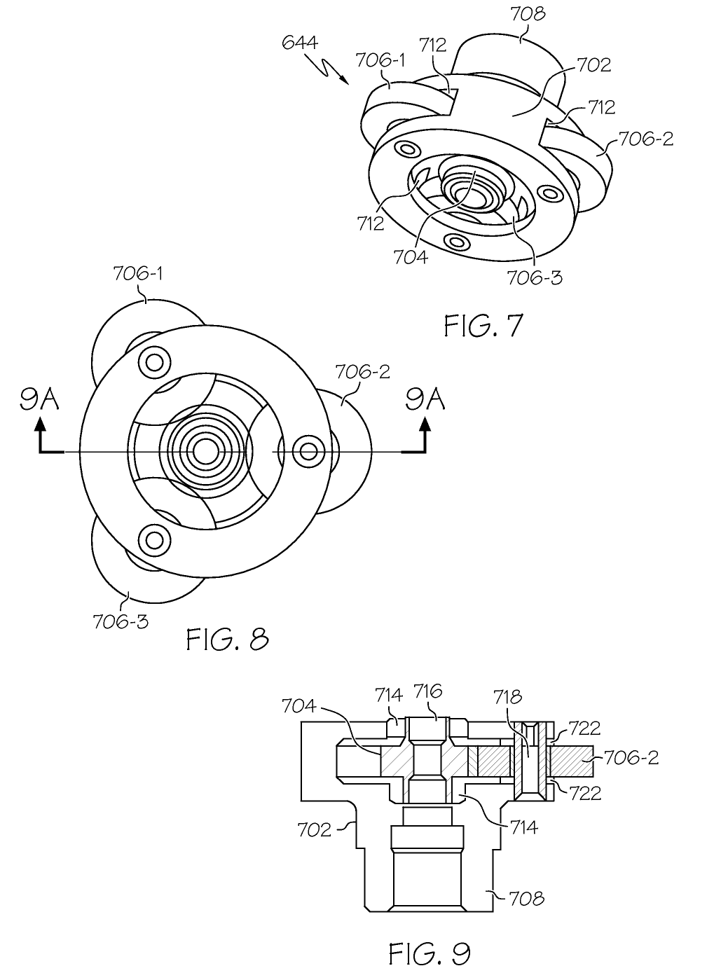

Turning now to a description of the actuator motor 116, and with continued reference to FIG. 6, it may be seen that the actuator motor 116 includes a stator 626 and a rotor 628, both of which are mounted within a motor housing assembly 632. The rotor 628 is rotationally mounted within the motor housing assembly 632, via a plurality of suitable bearing assemblies 634 (e.g., 634-1, 634-2), and is disposed within, and is spaced apart from, the stator 626. Thus, as is generally known, when the stator 626 is appropriately energized the rotor 628 will rotate. The rotor 628 additionally includes an inner surface 636 that defines an inner volume 63 8. A ring gear 642 is mounted on, and extends radially inwardly from, the rotor inner surface 636 into the rotor inner volume 638. As FIG. 6 further depicts, the output shaft 602 and the manual input shaft 618 each extend, from opposite ends of the rotor 628, into the rotor inner volume 638. The ring gear 642, the output shaft 602, and the manual input shaft 618 are each coupled to, or at least engage, a differential carrier assembly 644, which is disposed within the rotor inner volume 638. With quick reference to FIGS. 7-9, in combination with FIG. 6 when needed, an exemplary embodiment of the differential carrier assembly 644 is depicted and will now be described.

The differential carrier assembly 644, at least in the depicted embodiment, includes a carrier 702, a sun gear 704, and a plurality of planet gears 706 (e.g., 706-1, 706-2, 706-3). The carrier 702 includes an output shaft interface 708, and a plurality of planet gear slots 712. The sun gear 704 is rotationally mounted within the carrier 702 via suitable bearings 714. The sun gear 704 includes a manual input shaft interface 716, and engages each of the planet gears 706. The planet gears 706 are rotationally mounted within the carrier 702, via shafts 718 and bearings 722. Each of the planet gears 706 engages the sun gear 704 and extends through one of the planet gear slots 712.

Returning now to FIG. 6, it is seen that the carrier 702 is coupled to a carrier bearing support 646. The carrier 702 and carrier bearing support 646 are rotationally mounted within the rotor 628 via a plurality of suitable bearings 648. The carrier 702 is additionally coupled to the power-screw actuator 112 via the output shaft 602 and the plurality of output gears 604. In particular, at least in the depicted embodiment, a first end 652 of the output shaft 602 is disposed within and engages the carrier output shaft interface 708. The manual input shaft 618 is disposed within and engages the sun gear manual input shaft interface 716, thereby coupling the sun gear 704 to the bidirectional brake output 614 via the input gears 616. The planet gears 706, in addition to engaging the sun gear 704, engage the ring gear 642.

As FIG. 6 further depicts, the actuator 106 additionally includes a motor brake 654. The motor brake 654 is disposed within a motor brake housing 665, and is mounted adjacent the actuator motor 116. The motor brake 654 is selectively movable between an engaged position and a disengaged position. In the engaged position, the motor brake 654 prevents (or at least inhibits) rotation of the actuator motor rotor 628. In the disengaged position, the motor brake 654 does not prevent (or at least inhibit) rotation of the actuator motor rotor 628. Although various types of brakes may be used to implement the motor brake 654, in the depicted embodiment the motor brake is an electrical disc-brake type of device that may be selectively energized and deenergized. The depicted motor brake 654 is configured to be in the engaged position when it is deenergized, and in the engaged position when energized. Preferably, the actuator controller 104 is in operable communication with the motor brake 654, and is further operable to controllably energize and deenergize the motor brake 654.

Having described the overall construction and configuration of the hatch actuation control system 100, a brief description of its operation will now be provided. First, it is assumed that the hatch 102 is in the closed position and is going to be moved to its fully-open position using the actuator motor 116. The actuator controller 104, in response to externally supplied or manually inputted commands, controllably energizes the motor brake 654 to move it to the disengaged position, and controllably energizes the actuator motor 116 to rotate it in the appropriate direction. More specifically, the actuator controller 104 controllably energizes the actuator motor stator 626 to generate a torque in the actuator motor rotor 628 and cause the actuator motor rotor 628 to rotate in the appropriate direction.

As the actuator motor rotor 628 rotates, the ring gear 642 also rotates. The ring gear 642, as noted above, engages the planet gears 706, and thus imparts a torque to both the carrier 702 and sun gear 704. The bidirectional brake 608, as described above, constrains the sun gear 704 from rotating in response to this torque. The carrier 702, however, does rotate, and supplies a torque to the power-screw actuator 112, via the output shaft 602 and output gears 604, to impart a drive force to the hatch 102. As the hatch 102 is moved to the fully-open position, continuous position feedback is supplied to the actuator controller 104 from the position sensor 603. When the hatch 102 reaches the fully-open position, the actuator controller 104 will cease controllably energizing the actuator motor 116, and will deenergize the motor brake 654, thereby moving the motor brake 654 to its engaged position.

To move the hatch 102 to the closed position, the actuator controller 104 again energizes the motor brake 654, and selectively energizes the actuator motor 116 to rotate in the direction opposite to the direction that causes the hatch 102 to open. All other operations of the actuator 106 are identical, or at least substantially identical, to the above description. As such, the description will not be repeated. A description of how the hatch 102 is moved from its closed position to its fully-open position using the manual operator 114 will now be described.

When a manual input torque is supplied to the manual operator 114, the manual input torque is supplied, via the bidirectional brake 608 and input gears 616, to the manual input shaft 618. The manual input shaft 618 transfers the input torque to the sun gear 704, causing the sun gear 704 to rotate, which in turn causes the planet gears 706 to rotate. Because the motor brake 654 is engaged, the actuator motor rotor 628 and ring gear 642 are constrained from rotating. The planet gears 706 thus cause the carrier 702 to rotate and supply a drive torque, via the output shaft 602 and output gears 604, to the power-screw actuator 112. The power-screw actuator 112 will in turn supply a drive force to the hatch 102. The direction that the hatch 102 moves will depend, of course, on the direction in which the manual operator 114 is turned.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A high load lift and shock linear actuator, comprising:
a power-screw actuator coupled to receive a drive torque and operable, upon receipt thereof, to translate;
a manual operator configured to be manually rotated and operable, upon being manually rotated, to supply a manual input torque;
a bidirectional brake having an input and an output, the bidirectional brake input coupled to the manual operator, the bidirectional brake configured to (i) transfer manual input torque from the bidirectional brake input to the bidirectional brake output and (ii) prevent torque supplied to the bidirectional brake output from being transferred to the bidirectional brake input;
an actuator motor coupled to the power-screw actuator and adapted to be selectively energized, the actuator motor operable, upon being energized, to supply the drive torque to the power-screw actuator, the actuator motor comprising:
a stator,
a rotor disposed within, and spaced apart from, the stator, the rotor having an inner surface that defines an inner volume,
a ring gear mounted on the rotor inner surface, and
a differential carrier assembly disposed within the rotor inner volume and including a carrier, a sun gear, and a plurality of planet gears, the carrier rotationally mounted within the rotor and coupled to the power-screw actuator, the sun gear rotationally mounted within the carrier and coupled to the bidirectional brake output,
each planet gear disposed between and engaging the sun gear and the ring gear; and
a motor brake mounted adjacent the actuator motor and selectively movable between an engaged position, in which the motor brake at least inhibits rotation of the actuator motor rotor, and a disengaged position, in which the motor brake does not at least inhibit rotation of the actuator motor.

2. The actuator of claim 1, further comprising:
a manual input shaft coupled between the bidirectional brake output and the sun gear.

3. The actuator of claim 2, further comprising:
a plurality of manual input gears coupled between the bidirectional brake output and the manual input shaft.

4. The actuator of claim 3, wherein:
the sun gear includes a manual shaft interface;
the manual input shaft includes a first end and a second end;
the manual input shaft first end is coupled to the plurality of manual input gears; and
the manual input shaft second end is disposed within and engages the sun gear manual shaft interface.

5. The actuator of claim 1, further comprising:
an output shaft coupled between the carrier and the power-screw actuator.

6. The actuator of claim 5, further comprising:
a plurality of output gears coupled to the output shaft and engaging the power-screw actuator.

7. The actuator of claim 6, wherein:
the carrier includes an output shaft interface;
the output shaft includes a first end and a second end;
the output shaft first end is disposed within and engages the carrier shaft output shaft interface; and
the output shaft second end is coupled to the plurality of output gears.

8. The actuator of claim 1, further comprising:
a motor housing assembly enclosing the actuator motor and the motor brake.

9. A high load lift and shock actuation control system, comprising:
a power-screw actuator coupled to receive a drive torque and operable, upon receipt thereof, to translate;
a manual operator configured to be manually rotated and operable, upon being manually rotated, to supply a manual input torque;
a bidirectional brake having an input and an output, the bidirectional brake input coupled to the manual operator, the bidirectional brake configured to (i) transfer manual input torque from the bidirectional brake input to the bidirectional brake output and (ii) prevent torque supplied to the bidirectional brake output from being transferred to the bidirectional brake input;
an actuator motor coupled to the power-screw actuator and adapted to be controllably energized, the actuator motor operable, upon being controllably energized, to supply the drive torque to the power-screw actuator, the actuator motor comprising:
a stator,
a rotor disposed within, and spaced apart from, the stator, the rotor having an inner surface that defines an inner volume,
a ring gear mounted on the rotor inner surface, and
a differential carrier assembly disposed within the rotor inner volume and including a carrier, a sun gear, and a plurality of planet gears, the carrier rotationally mounted within the rotor and coupled to the power-screw actuator, the sun gear rotationally mounted within the carrier and coupled to the bidirectional brake output, each planet gear disposed between and engaging the sun gear and the ring gear;
a motor brake mounted adjacent the actuator motor and selectively movable, in response to being energized and deenergized, between an engaged position, in which the motor brake at least inhibits rotation of the actuator motor rotor, and a disengaged position, in which the motor brake does not at least inhibit rotation of the actuator motor; and
an actuator controller operable to controllably energize the actuator motor and to controllably energize and deenergize the motor brake.

10. The system of claim 9, further comprising:
a manual input shaft coupled between the bidirectional brake output and the sun gear.

11. The system of claim 10, further comprising:
a plurality of manual input gears coupled between the bidirectional brake output and the manual input shaft.

12. The system of claim 11, wherein:
the sun gear includes a manual shaft interface;
the manual input shaft includes a first end and a second end;
the manual input shaft first end is coupled to the plurality of manual input gears; and
the manual input shaft second end is disposed within and engages the sun gear manual shaft interface.

13. The system of claim 9, further comprising:
an output shaft coupled between the carrier and the power-screw actuator.

14. The system of claim 13, further comprising:
a plurality of output gears coupled to the output shaft and engaging the power-screw actuator.

15. The system of claim 14, wherein:
the carrier includes an output shaft interface;
the output shaft includes a first end and a second end;
the output shaft first end is disposed within and engages the carrier shaft output shaft interface; and
the output shaft second end is coupled to the plurality of output gears.

16. The system of claim 9, further comprising:
a motor housing assembly enclosing the actuator motor and the motor brake.

17. The system of claim 9, further comprising:
a rotational position sensor operable to sense rotational position of the carrier and supply a position feedback signal to the actuator controller.

18. A submarine hatch door position control system, comprising:
a hatch door rotationally movable between an open position and a closed position;
a power-screw actuator coupled to receive a drive torque and operable, upon receipt thereof, to translate and supply a force to the hatch door;
a manual operator configured to be manually rotated and operable, upon being manually rotated, to supply a manual input torque;
a bidirectional brake having an input and an output, the bidirectional brake input coupled to the manual operator, the bidirectional brake configured to (i) transfer manual input torque from the bidirectional brake input to the bidirectional brake output and (ii) prevent torque supplied to the bidirectional brake output from being transferred to the bidirectional brake input;
an actuator motor coupled to the power-screw actuator and adapted to be controllably energized, the actuator motor operable, upon being controllably energized, to supply the drive torque to the power-screw actuator, the actuator motor comprising:
a stator,
a rotor disposed within, and spaced apart from, the stator, the rotor having an inner surface that defines an inner volume,
a ring gear mounted on the rotor inner surface, and
a differential carrier assembly disposed within the rotor inner volume and including a carrier, a sun gear, and a plurality of planet gears, the carrier rotationally mounted within the rotor and coupled to the power-screw actuator, the sun gear rotationally mounted within the carrier and coupled to the bidirectional brake output, each planet gear disposed between and engaging the sun gear and the ring gear;
a motor brake mounted adjacent the actuator motor and selectively movable, in response to being energized and deenergized, between an engaged position, in which the motor brake at least inhibits rotation of the actuator motor rotor, and a disengaged position, in which the motor brake does not at least inhibit rotation of the actuator motor; and
an actuator controller operable to controllably energize the actuator motor and to controllably energize and deenergize to motor brake.

19. The control system of claim 18, further comprising:
a manual input shaft coupled between the bidirectional brake output and the sun gear; and
a plurality of manual input gears coupled between the bidirectional brake output and the manual input shaft, wherein:
the sun gear includes a manual shaft interface;
the manual input shaft includes a first end and a second end;
the manual input shaft first end is coupled to the plurality of manual input gears; and
the manual input shaft second end is disposed within and engages the sun gear manual shaft interface.

20. The control system of claim 18, further comprising:
an output shaft coupled between the carrier and the power-screw actuator; and
a plurality of output gears coupled to the output shaft and engaging the power-screw actuator, wherein:
the carrier includes an output shaft interface;
the output shaft includes a first end and a second end;
the output shaft first end is disposed within and engages the carrier shaft output shaft interface; and
the output shaft second end is coupled to the plurality of output gears.
